(19) United States
(12) Patent Application Publication
(10) Pub. No.: US 2011/0080351 A1
(43) Pub. Date: Apr. 7, 2011

(54) METHOD OF CONTROLLING TOUCH INPUT ON A TOUCH-SENSITIVE DISPLAY WHEN A DISPLAY ELEMENT IS ACTIVE AND A PORTABLE ELECTRONIC DEVICE CONFIGURED FOR THE SAME

(75) Inventors: Earl John WIKKERINK, Waterloo (CA); Michael George LANGLOIS, Almonte (CA); Michael Thomas HARDY, Waterloo (CA); Raymond Emmanuel MENDOZA, Waterloo (CA); Yoojin HONG, Palo Alto, CA (US); Rohit Rocky JAIN, Waterloo (CA); Orlin STOEV, Mississauga (CA)

(73) Assignee: RESEARCH IN MOTION LIMITED, Waterloo (CA)

(21) Appl. No.: 12/575,310

(22) Filed: Oct. 7, 2009

(51) Int. Cl. G06F 3/041; G06F 3/01; G06F 3/048; G09G 5/00

(52) U.S. Cl. 345/173; 715/863; 345/684; 715/764

(57) ABSTRACT

A method of controlling touch input on a touch-sensitive display when a display element is active and a portable electronic device configured for the same are provided. In accordance with one embodiment, there is provided a method of controlling touch input on a touch-sensitive display of a portable electronic device, the method comprising: displaying a widget having at least one field on a user interface screen displayed on the touch-sensitive display; selecting the field in the widget in response to predetermined interaction with the touch-sensitive display; changing the value of the selected field in accordance with a predetermined touch gesture at any location on the touch-sensitive display; and re-displaying the widget on the user interface screen with the changed value of the selected field.

### TECHNICAL FIELD

The present disclosure relates to computing devices, and in particular to a portable electronic devices having touch screen displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth™ capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. Performing repetitive actions on touch-sensitive displays while maintaining an efficient graphical user interface is a challenge for portable electronic devices having touch-sensitive displays. Accordingly, improvements in controlling inputs of touch-sensitive displays of portable electronic devices are desirable.

### BRIEF DESCRIPTION OF THE DRAWINGS

FIG. 1 is a simplified block diagram of components including internal components of a portable electronic device according to one aspect;

FIG. 2 is a front view of an example of a portable electronic device in a portrait orientation;

FIG. 3A is a sectional side view of portions of the portable electronic device of FIG. 2;

FIG. 3B is a side view of a portion of the portable electronic device shown in FIG. 3A;

FIG. 4 is a front view of an example of a portable electronic device in a portrait orientation, showing hidden detail in ghost outline;

FIG. 5 is a block diagram of a circuit for controlling the actuators of the portable electronic device in accordance with one example embodiment of the present disclosure;

FIGS. 6A and 6B are schematic diagrams of a user interface screen in accordance with one example embodiment of the present disclosure;

FIG. 7 is a schematic diagram of a user interface screen in accordance with another example embodiment of the present disclosure;

FIG. 8 is a schematic diagram of a user interface screen in accordance with a further example embodiment of the present disclosure;

FIG. 9 is a screen capture of a user interface screen in accordance with one example embodiment of the present disclosure;

FIG. 10 is a flowchart illustrating an example a method of controlling touch input on a touch-sensitive display when a display element is active in accordance with one example embodiment of the present disclosure;

FIG. 11A to 11B are screen captures of a user interface screen in accordance with other example embodiments of the present disclosure;

FIG. 12A to 12C are screen captures of a widget for the user interface screen of FIG. 11A or 11B; and

FIG. 13A to 13F are screen captures of time widget in accordance with one example embodiment of the present disclosure.

### DETAILED DESCRIPTION OF EXAMPLE EMBODIMENTS

The present disclosure provides a method of controlling touch input on a touch-sensitive display when a display element is active and a portable electronic device configured for the same. Precise targeting is difficult when using a touch-sensitive display, particularly when swiping on or over small onscreen targets. The present disclosure provides a mechanism for gross targeting rather than precise targeting when interacting with an active display element such as a selected field. The present disclosure describes, in at least some embodiments, a method and portable electronic device in which a swipe gesture anywhere on the touch-sensitive display changes the value of an active display element (e.g., incrementing or decrementing the value of a field which has been selected). The present disclosure may be particularly useful when swiping on or over a “spin dial” or “spin box” to change its value.

Advantageously, the method and portable electronic device taught by the present disclosure seek to reduce the targeting which is required before swiping. This can reduce the number of erroneous inputs generated when interacting with the touch-sensitive display which are inefficient in terms of processing resources, use unnecessary power which reduces battery life, and may result in an unresponsive user interface. Accordingly, the method and portable electronic device taught by the present disclosure seeks to provide improvements in these areas. The ability to interact with the selected field using other parts of the touch-sensitive display provides a larger area for interaction in which touch gestures can be performed, and provides a method of interacting with the selected field which does not obscure that field.

In accordance with one embodiment of the present disclosure, there is provided a method of controlling touch input on a touch-sensitive display of a portable electronic device, the method comprising: displaying a widget having at least one field on a user interface screen displayed on the touch-sensitive display; selecting a field in the widget in response to predetermined interaction with the touch-sensitive display; changing the value of the selected field in accordance with a predetermined touch gesture at any location on the touch-sensitive display; and re-displaying the widget on the user interface screen with the changed value of the selected field.

In accordance with another embodiment of the present disclosure, there is provided a portable electronic device, comprising: a processor; a touch-sensitive display having a touch-sensitive overlay connected to the processor; wherein the processor is configured for: causing a widget having at least one field to be displayed on a user interface screen displayed on the touch-sensitive display; selecting a field in the widget in response to predetermined interaction with the touch-sensitive display; changing the value of the selected field in accordance with a predetermined touch gesture at any location on the touch-sensitive display; and causing the widget to be re-displayed on the user interface screen with the changed value of the selected field.

In accordance with yet a further embodiment of the present disclosure, there is provided a computer program product comprising a computer readable medium having stored thereon computer program instructions for implementing a method on a portable electronic device for controlling its operation, the computer executable instructions comprising instructions for performing the method(s) set forth herein.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable electronic device in the embodiments described herein. Examples of portable electronic devices include mobile, or handheld, wireless communication devices such as pagers, cellular phones, cellular smart-phones, wireless organizers, personal digital assistants, wirelessly enabled notebook computers, and so forth. The portable electronic device may also be a portable electronic device without wireless communication capabilities, such as a handheld electronic game device, digital photograph album, digital camera, or other device.

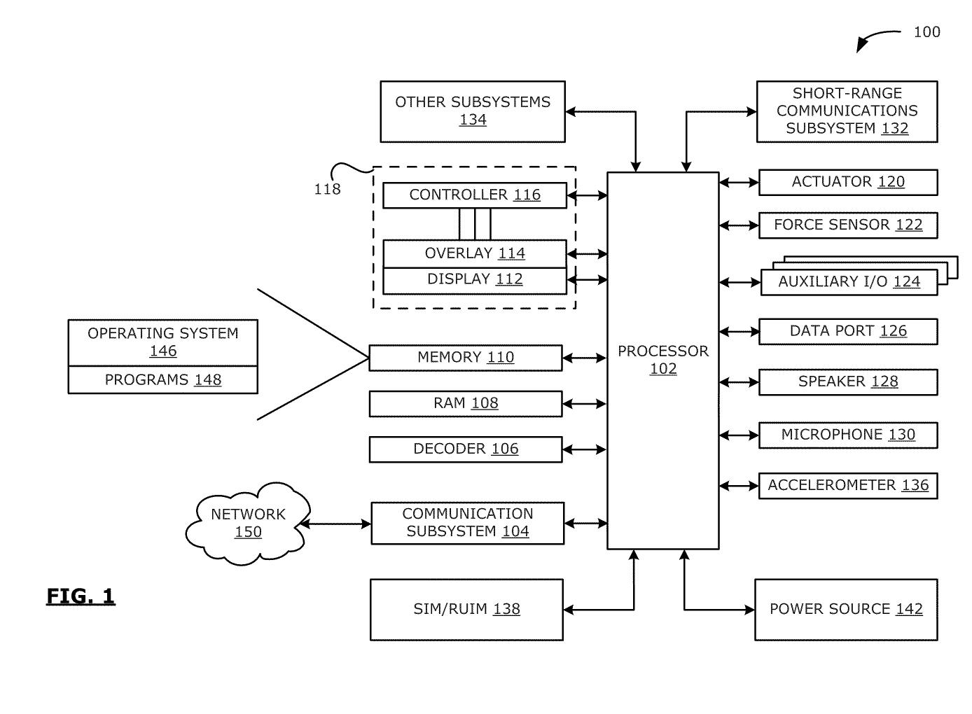

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 116, memory 110, a display screen 112 (such as a liquid crystal display (LCD)) with a touch-sensitive overlay 114 operably connected to an electronic controller 116 that together comprise a touch-sensitive display 118, one or more actuators 120, one or more force sensors 122, one or more auxiliary input/output (I/O) subsystems 124, a data port 126, a speaker 128, a microphone 130, short-range communications subsystem 132, and other device subsystems 134. User-interaction with a graphical user interface (GUI) is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software applications or programs 148 that are executed by the processor 102 and are typically stored in a persistent, updatable store such as the memory 110. Additional applications or programs 148 may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display screen 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

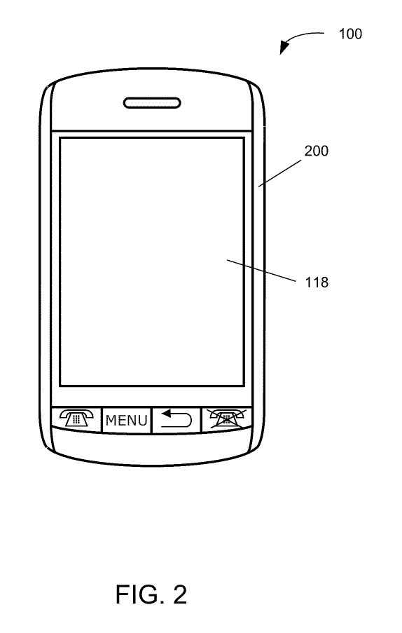

FIG. 2 shows a front view of an example of a portable electronic device 100 in portrait orientation. The portable electronic device 100 includes a housing 200 that houses internal components including internal components shown in FIG. 1 and frames the touch-sensitive display 118 such that the touch-sensitive display 118 is exposed for user-interaction therewith when the portable electronic device 100 is in use. It will be appreciated that the touch-sensitive display 118 may include any suitable number of user-selectable features rendered thereon, for example, in the form of virtual buttons for user-selection of, for example, applications, options, or keys of a keyboard for user entry of data during operation of the portable electronic device 100.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a centre of the area of contact. The location of a detected touch may include x and y components, e.g., horizontal and vertical components, respectively, with respect to one's view of the touch-sensitive display 118. For example, the x location component may be determined by a signal generated from one touch sensor, and the y location component may be determined by a signal generated from another touch sensor. A signal is provided to the controller 116 in response to detection of a touch. A touch may be detected from any suitable object, such as a finger, thumb, appendage, or other items, for example, a stylus, pen, or other pointer, depending on the nature of the touch-sensitive display 118. Multiple simultaneous touches may be detected.

The actuator(s) 120 may be depressed by applying sufficient force to the touch-sensitive display 118 to overcome the actuation force of the actuator 120. The actuator 120 may be actuated by pressing anywhere on the touch-sensitive display 118. The actuator 120 may provide input to the processor 102 when actuated. Actuation of the actuator 120 may result in provision of tactile feedback.

In some embodiments, the actuators 120 may comprise one or more piezoelectric devices that provide tactile feedback for the touch-sensitive display 118. The actuators 120 may be depressed by applying sufficient force to the touch-sensitive display 118 to overcome the actuation force of the actuators 120. The actuators 120 may be actuated by pressing anywhere on the touch-sensitive display 118. The actuator 120 may provide input to the processor 102 when actuated. Contraction of the piezoelectric actuators applies a spring-like force, for example, opposing a force externally applied to the touch-sensitive display 118. Each piezoelectric actuator includes a piezoelectric device, such as a piezoelectric (PZT) ceramic disk adhered to a metal substrate. The metal substrate bends when the PZT disk contracts due to build up of charge at the PZT disk or in response to a force, such as an external force applied to the touch-sensitive display 118. The charge may be adjusted by varying the applied voltage or current, thereby controlling the force applied by the piezoelectric disks. The charge on the piezoelectric actuator may be removed by a controlled discharge current that causes the PZT disk to expand, releasing the force thereby decreasing the force applied by the piezoelectric disks. The charge may advantageously be removed over a relatively short period of time to provide tactile feedback to the user. Absent an external force and absent a charge on the piezoelectric disk, the piezoelectric disk may be slightly bent due to a mechanical preload.

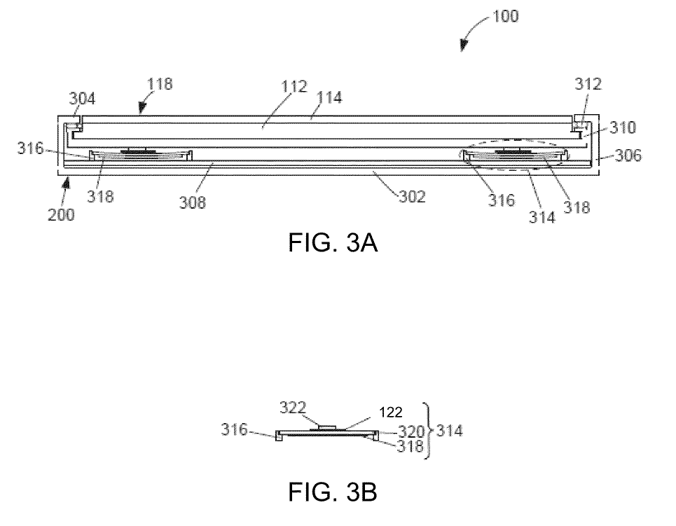

The housing 200 can be any suitable housing for the internal components shown in FIG. 1. FIG. 3A shows a sectional side view of portions of the portable electronic device 100 and FIG. 3B shows a side view of a portion of the actuators 120. The housing 200 in the present example includes a back 302, a frame 304, which frames the touch-sensitive display 118 and sidewalls 306 that extend between and generally perpendicular to the back 302 and the frame 304. A base 308 is spaced from and is generally parallel to the back 302. The base 308 can be any suitable base and can include, for example, a printed circuit board or flexible circuit board supported by a stiff support between the base 308 and the back 302. The back 302 may include a plate (not shown) that is releasably attached for insertion and removal of, for example, the power source 142 and the SIM/RUIM card 138 referred to above. It will be appreciated that the back 302, the sidewalls 306 and the frame 304 may be injection molded, for example. In the example of the portable electronic device 100 shown in FIG. 2, the frame 304 is generally rectangular with rounded corners, although other shapes are possible.

The display screen 112 and the touch-sensitive overlay 114 are supported on a support tray 310 of suitable material such as magnesium for providing mechanical support to the display screen 112 and touch-sensitive overlay 114. A compliant spacer such as gasket compliant 312 is located around the perimeter of the frame 304, between an upper portion of the support tray 310 and the frame 304 to provide a gasket for protecting the components housed in the housing 200 of the portable electronic device 100. A suitable material for the compliant gasket 312 includes, for example, a cellular urethane foam for providing shock absorption, vibration damping and a suitable fatigue life. In some embodiments, a number of compliant spacers may be provided to provide the function of the gasket compliant 312.

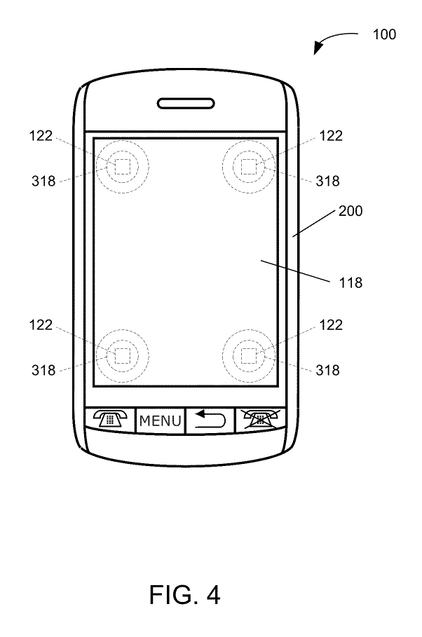

The actuators 120 includes four piezoelectric disk actuators 314, as shown in FIG. 4, with each piezoelectric disk actuator 314 located near a respective corner of the touch-sensitive display 118. Referring again to FIGS. 3A and 3B, each piezoelectric disk actuator 314 is supported on a respective support ring 316 that extends from the base 308 toward the touch-sensitive display 118 for supporting the respective piezoelectric disk actuator 314 while permitting flexing of the piezoelectric disk actuator 314. Each piezoelectric disk actuator 314 includes a piezoelectric disk 318 such as a PZT ceramic disk adhered to a metal substrate 320 of larger diameter than the piezoelectric disk 318 for bending when the piezoelectric disk 318 contracts as a result of build up of charge at the piezoelectric disk 318. Each piezoelectric disk actuator 314 is supported on the respective support ring 316 on one side of the base 308, near respective corners of the metal substrate 320, base 308 and housing 200. The support 316 ring is sized such that the edge of the metal substrate 320 contacts the support ring 316 for supporting the piezoelectric disk actuator 314 and permitting flexing of the piezoelectric disk actuator 314.

A shock-absorbing element 322, which in the present example is in the form of a cylindrical shock-absorber of suitable material such as a hard rubber is located between the piezoelectric disk actuator 314 and the support tray 310. A respective force sensor 122 is located between each shock-absorbing element 322 and the respective piezoelectric disk actuator 314. A suitable force sensor 122 includes, for example, a puck-shaped force sensing resistor for measuring applied force (or pressure). It will be appreciated that a force can be determined using a force sensing resistor as an increase in pressure on the force sensing resistor results in a decrease in resistance (or increase in conductance). In the portable electronic device 100, each piezoelectric disk actuator 314 is located between the base 308 and the support tray 310 and force is applied on each piezoelectric disk actuator 314 by the touch-sensitive display 118, in the direction of the base 308, causing bending of the piezoelectric disk actuator 314. Thus, absent an external force applied by the user, for example by pressing on the touch-sensitive display 118, and absent a charge on the piezoelectric disk actuator 314, the piezoelectric disk actuator 314 undergoes slight bending. An external applied force in the form of a user pressing on the touch-sensitive display 118 during a touch event, and prior to actuation of the piezoelectric disk actuator 314, causes increased bending of the piezoelectric disk actuator 314 and the piezoelectric disk actuator 314 applies a spring force against the touch-sensitive display 118. When the piezoelectric disk 318 is charged, the piezoelectric disk 318 shrinks and causes the metal substrate 320 and piezoelectric disk 318 to apply a further force, opposing the external applied force, on the touch-sensitive display 118 as the piezoelectric actuator 314 straightens.

Each of the piezoelectric disk actuators 314, shock absorbing elements 322 and force sensors 122 are supported on a respective one of the support rings 316 on one side of the base 308. The support rings 316 can be part of the base 308 or can be supported on the base 308. The base 308 can be a printed circuit board while the opposing side of the base 308 provides mechanical support and electrical connection for other components (not shown) of the portable electronic device 100. Each piezoelectric disk actuator 314 is located between the base 308 and the support tray 310 such that an external applied force on the touch-sensitive display 118 resulting from a user pressing the touch-sensitive display 118 can be measured by the force sensors 122 and such that the charging of the piezoelectric disk actuator 314 causes a force on the touch-sensitive display 118, away from the base 308.

In the present embodiment each piezoelectric disk actuator 314 is in contact with the support tray 310. Thus, depression of the touch-sensitive display 118 by user application of a force thereto is determined by a change in resistance at the force sensors 122 and causes further bending of the piezoelectric disk actuators 314 as shown in FIG. 3A. Further, the charge on the piezoelectric disk actuator 314 can be modulated to control the force applied by the piezoelectric disk actuator 314 on the support tray 310 and the resulting movement of the touch-sensitive display 118. The charge can be modulated by modulating the applied voltage or current. For example, a current can be applied to increase the charge on the piezoelectric disk actuator 314 to cause the piezoelectric disk 318 to contract and to thereby cause the metal substrate 320 and the piezoelectric disk 318 to straighten as referred to above. This charge therefore results in the force on the touch-sensitive display 118 for opposing the external applied force and movement of the touch-sensitive display 118 away from the base 308. The charge on the piezoelectric disk actuator 314 can also be removed via a controlled discharge current causing the piezoelectric disk 318 to expand again, releasing the force caused by the electric charge and thereby decreasing the force on the touch-sensitive display 118, permitting the touch-sensitive display 118 to return to a rest position.

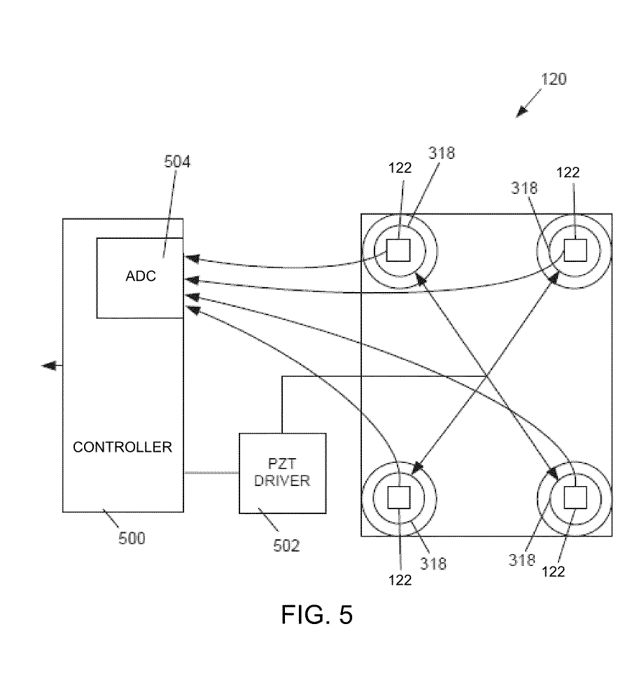

FIG. 5 shows a circuit for controlling the actuators 120 of the portable electronic device 100 according to one embodiment. As shown, each of the piezoelectric disks 318 is connected to a controller 500 such as a microprocessor including a piezoelectric driver 502 and an amplifier and analog-to-digital converter (ADC) 504 that is connected to each of the force sensors 122 and to each of the piezoelectric disks 318. In some embodiments, the ADC 504 is a 9-channel ADC. The controller 500 is also in communication with the main processor 102 of the portable electronic device 100. The controller 500 can provide signals to the main processor 102 of the portable electronic device 100. It will be appreciated that the piezoelectric driver 502 may be embodied in drive circuitry between the controller 500 and the piezoelectric disks 318.

The mechanical work performed by the piezoelectric disk actuator 314 can be controlled to provide generally consistent force and movement of the touch-sensitive display 118 in response to detection of an applied force on the touch-sensitive display 118 in the form of a touch, for example. Fluctuations in mechanical work performed as a result of, for example, temperature, can be reduced by modulating the current to control the charge.

The controller 500 controls the piezoelectric driver 502 for controlling the current to the piezoelectric disks 318, thereby controlling the charge. The charge is increased to increase the force on the touch-sensitive display 118 away from the base 308 and decreased to decrease the force on the touch-sensitive display 118, facilitating movement of the touch-sensitive display 118 toward the base 308. In the present example, each of the piezoelectric disk actuators 314 are connected to the controller 500 through the piezoelectric driver 502 and are all controlled equally and concurrently. Alternatively, the piezoelectric disk actuators 314 can be controlled separately.

The portable electronic device 100 is controlled generally by monitoring the touch-sensitive display 118 for a touch event thereon, and modulating a force on the touch-sensitive display 118 for causing a first movement of the touch-sensitive display 118 relative to the base 308 of the portable electronic device 100 in response to detection of a touch event. The force is applied by at least one of the piezoelectric disk actuators 314, in a single direction on the touch-sensitive input surface of the touch-sensitive display 118. In response to determination of a touch event, the charge at each of the piezoelectric disks 318 is modulated to modulate the force applied by the piezoelectric disk actuators 314 on the touch-sensitive display 118 and to thereby cause movement of the touch-sensitive display 118 for simulating the collapse of a dome-type switch. When the end of the touch event is detected, the charge at each of the piezoelectric disks 318 is modulated to modulate the force applied by the piezoelectric disk actuators 314 to the touch-sensitive display 118 to cause movement of the touch-sensitive display 118 for simulating release of a dome-type switch.

The touch-sensitive display 118 is moveable within the housing 200 as the touch-sensitive display 118 can be moved away from the base 308, thereby compressing the compliant gasket 312, for example. Further, the touch-sensitive display 118 can be moved toward the base 308, thereby applying a force to the piezoelectric disk actuators 314. By this arrangement, the touch-sensitive display 118 is mechanically constrained by the housing 200 and resiliently biased by the compliant gasket compliant 312. In at least some embodiments, the touch-sensitive display 118 is resiliently biased and moveable between at least a first position and a second position in response to externally applied forces wherein the touch-sensitive display 118 applies a greater force to the force sensors 122 in the second position than in the first position. The movement of the touch-sensitive display 118 in response to externally applied forces is detected by the force sensors 122.

The analog-to-digital converter 504 is connected to the piezoelectric disks 318. In addition to controlling the charge at the piezoelectric disks 318, an output, such as a voltage output, from a charge created at each piezoelectric disk 318 may be measured based on signals received at the analog to digital converter 504. Thus, when a pressure is applied to any one of the piezoelectric disks 318 causing mechanical deformation, a charge is created. A voltage signal, which is proportional to the charge, is measured to determine the extent of the mechanical deformation. Thus, the piezoelectric disks 318 also act as sensors for determining mechanical deformation.

In other embodiments, the actuator 120 is a mechanical dome-type switch or a plurality of mechanical dome-type switches, which can be located in any suitable position such that displacement of the touch-sensitive display 118 resulting from a user pressing the touch-sensitive display 118 with sufficient force to overcome the bias and to overcome the actuation force for the switch, depresses and actuates the switch.

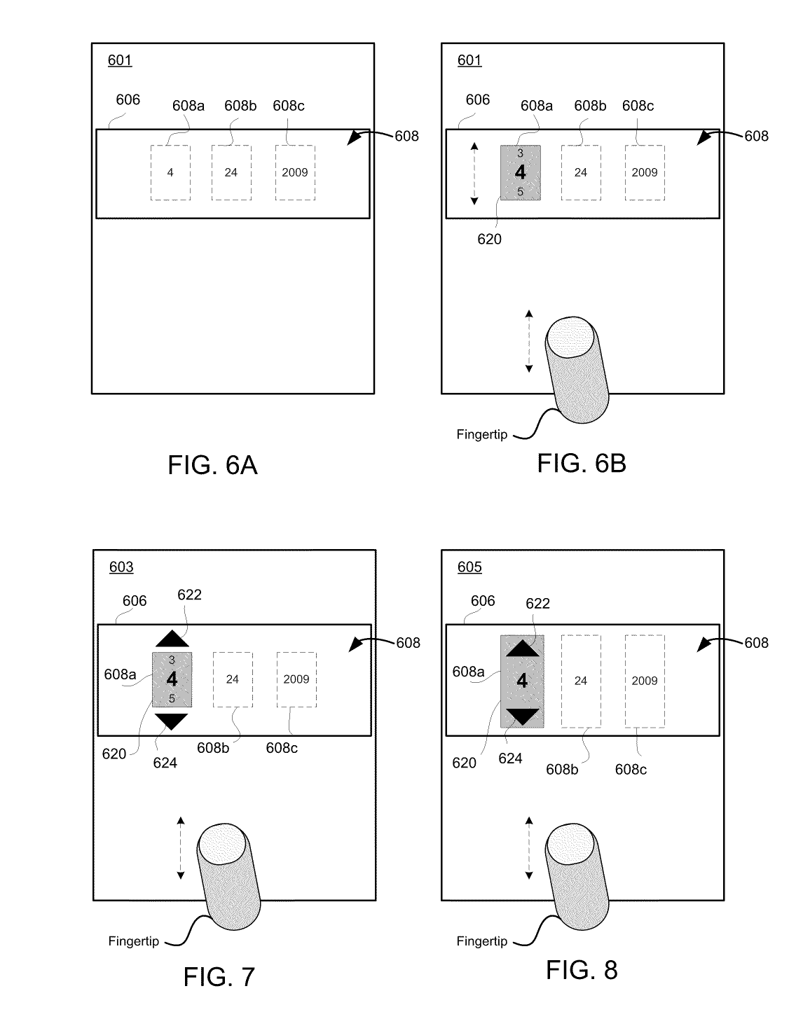

FIGS. 6A and 6B are schematic diagrams of a user interface screen 601 in accordance with one example embodiment of the present disclosure. The screen 601 may be for any application 148 on the device 100 including, but not limited to, a clock application or calendar application. A control interface in the form of a widget 606 is displayed on the display 112 in response to predetermined interaction with the screen 601 via the touch-sensitive overlay 114. In the shown embodiment, the widget 606 overlays a portion of the screen 601. In other embodiments, the widget 606 may be embedded or provided inline within the content of screen 601. The widget 606 may be a date selection widget, time selection widget or date and time selection widget for managing the date and/or time of the operating system 146 or managing the date and/or time of an object in an application 148 such as, but not limited to, the clock application or calendar application.

As will be appreciated by persons skilled in the art, the widget 606 is an element of the GUI which provides management of user configurable information, such as the date and time of the operating system 146, or the date and time of a calendar object for a calendar event. As described herein, a widget displays information which is manageable or changeable by the user in a window or box presented by the GUI. In at least some embodiments, the widget provides a single interaction point for the manipulation of a particular type of data. All applications 148 on the device 100 which allow input or manipulation of the particular type of data invoke the same widget. For example, each application 148 which allows the user to manipulate date and time for data objects or items may utilize the same and time selection widget. Widgets are building blocks which, when called by an application 148, process and manage available interactions with the particular type of data

As mentioned, the widget 606 is displayed in response to a predetermined interaction with the screen 601 via the touch-sensitive overlay 114. Such a predetermined interaction can be, but is not limited to, a user input for invoking or displaying the widget 606, a user input received in response to a prompt, and a user input directed to launching an application 148.

The widget 606 occupies only a portion of the screen 601 in the shown embodiment. The widget 606 has a number of selectable fields each having a predefined user interface area indicated individually by references 608a, 608b and 608c. In the shown embodiment, the fields define a date and comprise a month field, day field and year field having values of “4”, “24” and “2009” respectively (i.e., Apr. 24, 2009). While the month field is numeric in the shown embodiment, in other embodiments the month field may be the month name. The day of week (e.g., “Wed”) may be included in addition to or instead of the numeric day field.

In other embodiments, the fields may define a date and a time. The fields may comprise a month field, day field, year field, hour field and minute field. The fields may further comprise a day of week field, for example as the leading or first field, an AM/PM indicator, for example as the terminal or last field, or both. In embodiments in which a 24-hour clock is used an AM/PM indicator is not required and so may be eliminated. In yet other embodiments, the fields may define a time. The fields may comprise an hour field and minute field.

The predefined user interface areas 608a-c of the selectable fields are shown using ghost outline to indicate that the field boundaries are hidden. The boundaries of the predefined user interface areas 608a-c are typically not displayed in practice, but are shown in FIGS. 6A and 6B for the purpose of explanation. FIG. 6A shows the widget 606 when none of the fields are selected; however, in some embodiments one of the fields is always selected. When the widget 606 is first displayed after being invoked, a default field may be selected automatically. Fields in the widget 606 can be selected by corresponding interaction with the touch-sensitive display 114. For example, touching the predefined user interface area 608a, 608b or 608c associated with a respective field will select that field.

When a field is selected, an onscreen position indicator (also known as the “caret” or “focus”) 620 is moved to the selected field. The onscreen position indicator changes the appearance of the selected field to provide a visual indication of which field is currently selected. The onscreen position indicator 620 may change the background colour of the selected field, text colour of the selected field or both. In some embodiments, the onscreen position indicator 620 causes the background colour of the selected field to be blue and the text colour of the selected field to be white. In contrast, the background colour of an unselected field may be black and the text colour of an unselected field may be white. In other embodiments, the background colour may be white and the text colour may be black when a field is unselected. It will be understood that the present disclosure is not limited to any colour scheme used for fields of the widget 606 to show its status as selected or unselected.

Once a field is selected, the value of that field may be changed in accordance with corresponding touch gestures. A touchscreen gesture is a predetermined touch gesture performed by touching the touch-sensitive display 118 in a predetermined manner, typically using a finger. The predetermined touch gesture can be performed at any location on the touch-sensitive display 118. In at least some embodiments, the initial contact point of the predetermined touch gesture must not be at a location of a selectable field other than currently selected field or the touch event may select that other field and the predetermined touch gesture will be associated with that other field.

It will be appreciated that in some embodiments two distinct touch events may be required: an initial selection event in which a field of the widget 606 is selected and a predetermined touch gesture performed while a field in the widget 606 is selected. Two distinct touch events assist in resolving ambiguity between touch events on the touch-sensitive display 118.

The predetermined touch gesture may be a movement in a predetermined direction, i.e. a touch event having a centroid which moves during the touch event by an amount which exceeds a predetermined distance (typically measured in displayed pixels). In some embodiments, the vertical movement relative to the screen orientation of the GUI causes the value of the selected field to be changed when the distance of that movement exceeds the predetermined distance. The predetermined distance is used to debounce touch events to prevent small inadvertent movements of the centroid of the touch event from causing the value of the selected field to be changed. The predetermined distance may be quite small (e.g. a few pixels) and could be a user configurable parameter. In other embodiments, the predetermined distance could be omitted. In some embodiments, an upward movement of the centroid of the touch event moves or advances the value of the selected field forward through a sequence list of values for the field, and a downward movement of the centroid of the touch event moves or advances the value of the selected field backward through the sequence list of values for the field. However, the effect of upward and downward movement may be switched in other embodiments.

In some embodiments, the predetermined touch gesture may comprise a horizontal movement as well as a vertical movement provided the amount of vertical movement exceeds the predetermined distance. Accordingly, the predetermined movement could be vertical movement (i.e., an up or down movement) or a diagonal movement (i.e., an up-right, down-right, up-left or down-left movement). In other embodiments, the predetermined movement may be strictly a vertical movement, i.e., an up or down movement. Touch data reported by the touch-sensitive display 118 may be analyzed to determine whether the horizontal component of the movement is less than a predetermined threshold. When the horizontal component is less than the predetermined threshold, the movement is considered vertical. When the horizontal component is more than the predetermined threshold, the movement is not considered vertical.

In other embodiments, the horizontal movement relative to the screen orientation of the GUI causes the value of the selected field to be changed when the distance of that movement exceeds the predetermined distance. For example, a leftward movement may move or advance the value of the selected field forward through the sequence list of values for the field, and a rightward movement may move or advance the value of the selected field backward through the sequence list of values for the field. The touch gesture may comprise a vertical movement as well as a horizontal movement provided the amount of the horizontal movement exceeds the predetermined distance. In other embodiments, the predetermined movement may be strictly a horizontal movement, i.e., a left or right movement.

In some embodiments, the predetermined touch gesture may comprise a number of movements and the movement of the touch event is evaluated during the event and is evaluated with respect to an initial contact point centroid) of the touch event. When a first movement in the centroid of the touch event relative to the initial contact point which exceeds the predetermined distance is detected, the value of the selected field is changed accordingly. If a second movement in the centroid of the touch event relative to the initial contact point which exceeds the predetermined distance is detected during the same touch event, the value is again changed accordingly. This may occur regardless of whether the second movement is in the same direction or a different direction from the first movement. The possibility for multiple directions and changes in the value of the selected field during a single touch event may result in the value of the selected field being moved both forward and backwards through the sequential list of values during the same touch event, and may result in the value of the selected field being returned to its original value at the end of the touch event.

In some embodiments, the amount by which the value of the selected field is moved through the sequential list is proportional to the distance that the centroid of the touch event has moved relative to the initial contact point. The number of positions in the sequential list that the value is moved may be proportional to a multiplier calculated as the distance from the initial contact point divided by the predetermined distance to recognize a movement (rounded to the nearest integer). For example, if the predetermined distance to recognize a movement is 5 pixels and the distance from the initial contact point that the centroid of the touch event has moved is 25, the value of the selected field is moved by 5 positions (25/5=5) in a given direction.

The predetermined touch gesture may also be a swipe gesture. Unlike the movements described above, swipe gestures are evaluated after the event has ended. Swipe gestures have a single direction and do not comprise a number of movements. The direction of the swipe gesture is evaluated with respect to an initial contact point of the touch event at which the finger makes contact with the touch-sensitive display 118 and a terminal or ending contact point at which the finger is lifted from the touch-sensitive display 118.

Examples of swipe gestures include a horizontal swipe gesture and vertical swipe gesture. A horizontal swipe gesture typically comprises an initial contact with the touch-sensitive display 118 towards its left or right edge to initialize the gesture, followed by a horizontal movement of the point of contact from the location of the initial contact to the opposite edge while maintaining continuous contact with the touch-sensitive display 118, and a breaking of the contact at the opposite edge of the touch-sensitive display 118 to complete the horizontal swipe gesture. Similarly, a vertical swipe gesture typically comprises an initial contact with the touch-sensitive display 118 towards its top or bottom edge to initialize the gesture, followed by a vertical movement of the point of contact from the location of the initial contact to the opposite edge while maintaining continuous contact with the touch-sensitive display 118, and a breaking of the contact at the opposite edge of the touch-sensitive display 118 to complete the vertical swipe gesture. Such swipe gestures can be of various lengths, can be initiated in various places on the touch-sensitive display 118, and need not span the full dimension of the touch-sensitive display 118. In addition, breaking contact of a swipe can be gradual, in that contact pressure on the touch-sensitive display 118 is gradually reduced while the swipe gesture is still underway.

While interaction with the touch-sensitive display 118 is described in the context of fingers of a device user, this is for purposes of convenience only. It will be appreciated that a stylus or other object may be used for interacting with the touch-sensitive display 118 depending on the type of touchscreen display 210.

In at least some embodiments, the value of a selected field is advanced or moved forwards through an ordered or sequential list of values of the field in response to an upward swipe gesture at any location on the touch-sensitive display 118. An upward swipe gesture starts at a point on the touch-sensitive display 118 (e.g., near the bottom edge) and moves upwards from the point of view of the person conducting the swipe. Conversely, the value of a selected field is reversed or moved backwards through the sequential list of predetermined values of the field in response to a downward swipe gesture at any location on the touch-sensitive display 118. A downward swipe gesture starts at a point on the touch-sensitive display 118 (e.g., near the top edge) and moves downwards from the point of view of the person conducting the swipe. The movement through the sequential list of values is sometimes referred to as “scrolling”. When the end of the sequential list is reached, the sequential list may be configured such that the values in the sequential list wrap around to the beginning of the sequential list and vice versa. Wrapping may provide more efficient navigation and interaction with the fields for changing their values. In other embodiments, the fields may not wrap. Instead, scrolling stops at the beginning or end of the sequential list. In some embodiments, whether a field wraps may be a configurable parameters.

In at least some embodiments, the amount of scrolling is proportional to the distance of the swipe gesture. For example, a long swipe gesture may move several values in the sequential list, whereas a shorter swipe gesture may move only fewer values in the sequential list including possibly only one. The proportionality is controlled by a multiplier which may be user configurable allowing the user to control the effect of finger movement on scrolling. Thus, different multipliers may be used in different embodiments. In other embodiments, the ratio of scrolling to the number of swipe gestures is 1:1. That is, the value of the selected field is moved through the sequential list or changed by one for each swipe gesture.

It should be noted that neither the upward swipe gesture nor downward swipe gesture need to be performed over the selected field. The field need only be selected by touching the respective predefined user interface area 608a, 608b, or 608c, after which a swipe gesture performed any where on the touch-sensitive display 118 will scroll through the sequential list of values in the appropriate direction. In some embodiments, a touch to select the desired user interface area 608a, 608b, or 608c is also the initial contact of the swipe gesture, such that the swipe gesture begins within the desired user interface area 608a, 608b, or 608c and ends outside the desired user interface area 608a, 608b, or 608c. This can be contrasted with conventional precision targeting which requires a gesture to be performed over the display element to be changed.

The sequential list of predetermined values for a field is context-dependent. That is, the sequential list of predetermined values for a field depends on the definition of the field. For example, when the field is a month field, the sequential list of predetermined values is defined by the months of the year. When the field is the day of week field, the sequential list of predetermined values is defined by the days of the week. When the field is the day field, the sequential list of predetermined values is defined by the days of the month (which will depend on the value of the month field).

Referring again to FIG. 6B, in the selected field the current value is shown in bold or large font or type. The values before and after the current value within the sequential list of predetermined values for the field are also shown. In the shown embodiment, the value after the current value of the field is shown below the current value, whereas the value before the current value of the field is shown above the current value. This provides a visual indication of the type of interaction that is required to change the value of a selected field, for example a direction of a touch gesture required to move forward or backward through the sequential list of values. In the example shown in FIG. 6B, the current value is “4” and the value before it is “3” and the value after it is “5”. In other embodiments, the location of the value before and after the current value may be switched.

In some embodiments, horizontal swipe gestures may be used to move between fields in the widget 606 thereby changing the selected field. For example, a leftward swipe gesture may be used to move leftward through the fields of the widget 606. A leftward swipe gesture starts at a point on the touch-sensitive display 118 (e.g., near the right edge) and moves leftwards. Conversely, a rightward swipe gesture may be used to move rightwards through the fields of the widget 606. A rightward swipe gesture starts at a point on the touch-sensitive display 118 (e.g., near the left edge) and moves rightwards.

Referring now to FIG. 7, an alternate embodiment of a user interface screen 603 is shown. In this embodiment, directional arrows 622 and 624 are provided as part of the GUI above and below the selected field. An up-arrow 622 is provided above the selected field and a down-arrow 624 is provided below the selected field in the in this embodiment. In the shown embodiment of FIG. 7, the directional arrows 622 and 624 are not part of the predefined user interface areas 608. FIG. 8 shows an alternate embodiment of a user interface screen 605 in which the directional arrows 622 and 624 are part of the predefined user interface areas 608. In this embodiment, the values before and after the current value of the selected field are not shown.

In some embodiments, pressing the touch-sensitive display 118 at the location of the up-arrow 622 actuates the actuator 120 and moves the value of the field forward through the sequential list of values for the field, and the pressing the touch-sensitive display 118 at the location of the down-arrow 624 actuates the actuator 120 and moves the value of the field backwards through the set of predetermined values for the field. In some embodiments, pressing or “clicking” the touch-sensitive display 118 at the location of the up-arrow 622 moves the value of the field forward through the sequential list by one value (e.g., increments the current value of the selected field by one), and pressing or “clicking” the touch-sensitive display 118 at the location of the down-arrow 624 moves the value of the field backward through the sequential list by one value (e.g., decrements the current value of the selected field by one).

In other embodiments, touching the up-arrow 622 or down-arrow 624 without pressing the touch-sensitive display 118 changes the value of the selected field by scrolling forwards or backwards as described above. In some embodiments, the touch event at the up-arrow 622 or down-arrow 624 must exceed a predetermined duration to change the value of the selected field. This requires a user to “hover” over the up-arrow 622 or down-arrow 624 to cause a corresponding change in the value of the selected field. The requirement for a time may reduce erroneous inputs to change the value of the selected field.

The user interface solution for the fields described above is sometimes referred to as a “spin dial” or “spin box”. The widget 606 of FIGS. 6A to 8 has three spin boxes: the month field, the day field, and the year field. The teachings above can be applied to any number of spin boxes which can be provided in a widget or elsewhere in the GUI. The spin boxes may be managed by a spin box manager (not shown) which is part of a user interface (UI) manager (not shown) for the device 100. The user interface manager renders and displays the GUI of the device 100 in accordance with instructions of the operating system 146 and programs 148. The spin box manager enforces a common appearance of across the controlled spin boxes e.g. height, visible rows, and padding.

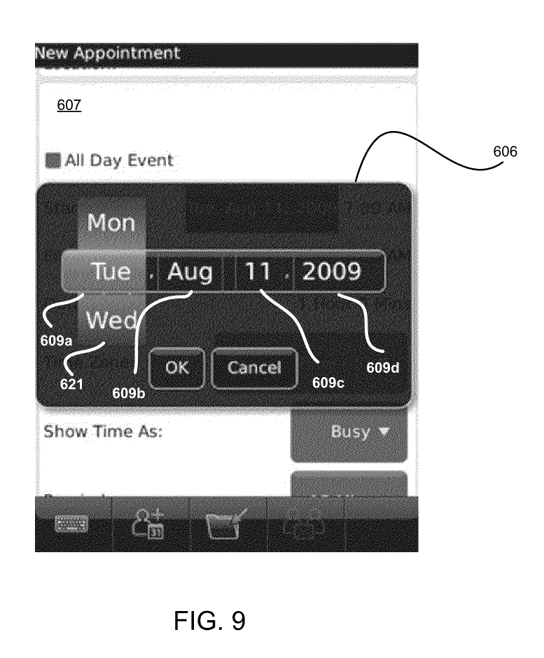

FIG. 9 shows a screen capture of a new appointment user interface screen 607 for a calendar application in accordance with one example embodiment of the present disclosure. The fields of the widget 606 are defined by references 609a, 609b, 609c, and 609d. In the shown embodiment, the fields define a date and comprise a day of week field, month field, day field and year field having values of “Tue” or “Tuesday, “Aug” or “August”, “11” and “2009” respectively (i.e., Tuesday, Aug. 11, 2009). The value before the current value (e.g. “Mon” or “Monday”) in the sequential list is provided above the current value, whereas the value after the current value (e.g. “Wed” or “Wednesday”) in the sequential list is provided below the current value.

An onscreen position indicator 621 is used to show the selected field as described above, however, the values in the sequential list before and after the current value are de-emphasized by the onscreen position indicator 621 relative the current value. In the shown embodiment, the onscreen position indicator 621 is smaller (e.g. thinner) over the before and after values relative to the current value, and as colour gradient which diminishes in colour intensity (becomes transparent) in the vertical direction moving away from the current value. The combination of user interface features in FIG. 9 provides a visual indication that of how interaction with the touch-sensitive display 118 can change the value of the selected field, i.e. that an upward or downward swipe will scroll backwards or forwards, respectively.

While the present disclosure is primarily directed to a widget for date fields, time fields or date and time fields, the teachings of the present disclosure can be applied to provide an efficient and user friendly widget or similar user interface element for changing the value of a field from a sequential list of predetermined values, or selecting an item from a sequential list. Examples of sequential lists include numbers, dates, words, names, graphical symbols or icons, or any combination of these. While the examples of sequential lists described herein are text values, the sequential lists need not be limited to text.

It will also be appreciated that the date field, time fields and date and time fields are associated with a clock or calendar application and that changes in the value of at least some of the subfields of these fields may trigger changes in the values of other subfields in accordance with predetermined logical rules governing the clock and calendar.

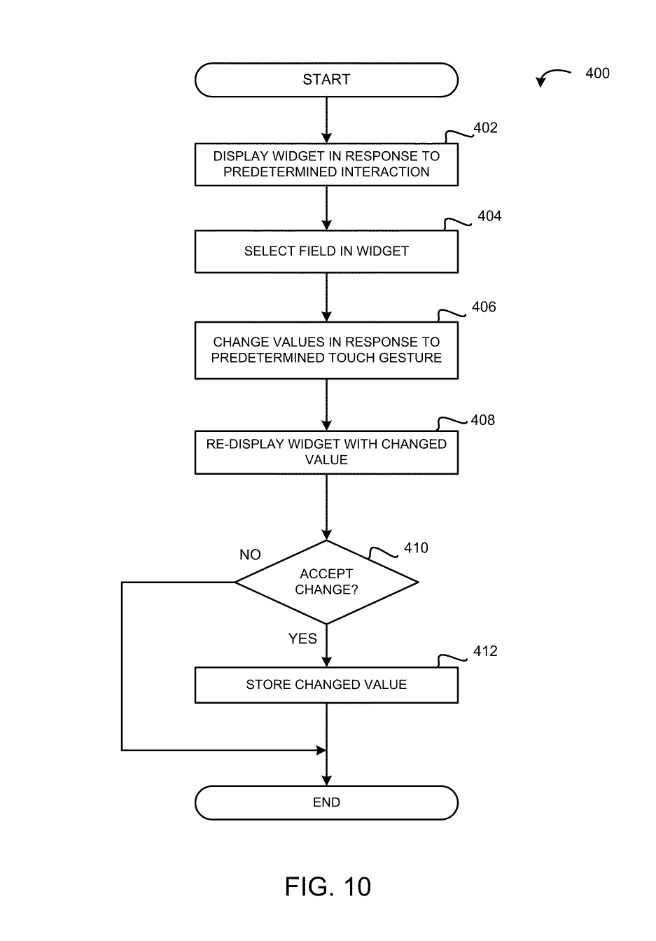

Referring now to FIG. 10, an example process 400 for a method of controlling touch input on a touch-sensitive display of a portable electronic device in accordance with one embodiment of the present disclosure will be described. The steps of FIG. 10 may be carried out by routines or subroutines of software executed by, for example, the processor 102. The coding of software for carrying out such steps is well within the scope of a person of ordinary skill in the art given the present disclosure.

First, at step 402 the widget 606 is rendered by a UI manager (not shown) and displayed on the display 112 in response to predetermined interaction with the touch-sensitive display 118. An example of such predetermined interaction is, but is not limited to, a finger or stylus touching the touch-sensitive display 118 at the location of a user interface element having an invokable widget 606 associated with it, or pressing the touch-sensitive display 118 at the location of the user interface element having an invokable widget 606. Alternatively, the predetermined interaction may involve selecting a corresponding menu option from a corresponding menu to invoke the widget 606. As noted above, the widget 606 comprises at least one field but typically a number of fields which may be spin boxes. The widget 606 is displayed on the user interface screen from which it was invoked and occupies a portion of the user interface screen.

Next, at step 404 a field in the widget 606 is selected. Typically the field is selected in response to predetermined interaction with the touch-sensitive display 118; however, the selected field may be a default field selected automatically upon invocation of the widget 606 as described above. An example of such predetermined interaction is, but is not limited to, a finger or stylus touching the touch-sensitive display 118 at the location of the field.

Next, in step 406 the value of the selected field is changed in response to a predetermined touch gesture at any location on the touch-sensitive display. The original value of the selected field and the changed value of the selected field is stored, typically in RAM 108. The predetermined touch gesture may be a movement in a predetermined direction, i.e. a touch event having a centroid which moves during the touch event by an amount which exceeds a predetermined distance (typically measured in displayed pixels). In some embodiments, the predetermined touch gesture is a vertical movement which exceeds the predetermined distance.

In some embodiments, an upward movement of the centroid of the touch event moves or advances the value of the selected field forward through the sequence list of values for the field, and a downward movement of the centroid of the touch event moves or advances the value of the selected field backward through the sequence list of values for the field. However, the effect of upward and downward movement may be switched in other embodiments.

In other embodiments, a swipe gesture in a first direction at any location on the touch-sensitive display scrolls forward through a sequential list of values for the field to select a new value for the field. Conversely, a swipe gesture in a second direction at any location on the touch-sensitive display scrolls backward through the sequential list of values for the field to select a new value for the field. The swipe gesture in the first direction may be an upward swipe gesture and the swipe gesture in the second direction may be a downward swipe gesture in some embodiments.

In some embodiments, the amount by which the value of the selected field is moved through the sequential list is proportional to the distance that the centroid of the touch event has moved relative to the initial contact point.

Next, in step 408 the widget 606 and possibly the user interface screen is re-rendered and re-displayed on the display screen 112 in accordance with the changed value of the selected field.

To exit or close the widget 606, input accepting or rejecting a change in the value of the fields of the widget 606 may be required (step 410). When input accepting a change in the value of the fields of the widget 606 is received, the changed value(s) are stored in the memory 110 of the device 100 (step 412) and the widget 606 is removed from the touch-sensitive display 118. When exiting the widget 606, the user interface screen is re-rendered and re-displayed accordingly. Referring to FIG. 9, in some embodiments changes may be accepted by activating or “clicking” an “Ok” virtual button in the widget 606, for example, by pressing the touch-sensitive display 118 at the location of the “Ok” virtual button in the widget 606.

When input rejecting a change in the value of the fields of the widget 606 is received, the changed value(s) for one or more fields in the widget 606 are discarded and the process 400 ends. Referring to FIG. 9, in some embodiments any changes may be accepted by activating or “clicking” a “Cancel” virtual button in the widget 606, for example, by pressing the touch-sensitive display 118 at the location of the “Cancel” virtual button in the widget 606.

While not shown in FIG. 10, when the widget 606 comprises multiple fields, different fields can be selected and their values changed in the same manner as described above. In some embodiments, predetermined touch gestures can be used to select different fields in the widget 606, for example, to scroll or move between fields in the widget 606. In some embodiments, a leftward swipe gesture at any location on the touch-sensitive display scrolls leftward through the fields in the widget to select a new field. Conversely, a rightward swipe gesture at any location on the touch-sensitive display scrolls rightward through the fields in the widget to select a new field.

While the process 400 has been described as occurring in a particular order, it will be appreciated by persons skilled in the art that some of the steps may be performed in a different order provided that the result of the changed order of any given step will not prevent or impair the occurrence of subsequent steps. Furthermore, some of the steps described above may be combined in other embodiments, and some of the steps described above may be separated into a number of sub-steps in other embodiments.

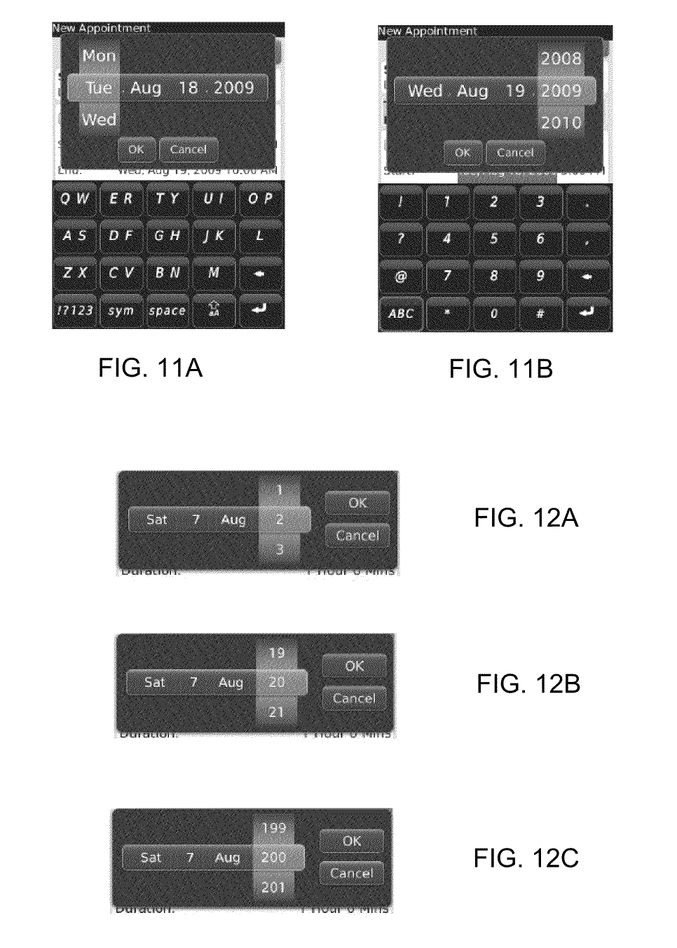

Referring now to FIGS. 11A to 12C, further examples embodiment of the present disclosure will be described. In the illustrated embodiment, a virtual keyboard or keypad may be invoked via predetermined interaction with the touch-sensitive display 118 while a field in a widget is selected. FIG. 11A shows a virtual keyboard in accordance with other example embodiment. The shown virtual keyboard is a reduced keyboard provided by a portrait screen orientation; however, a full keyboard could be used in a landscape screen orientation or in a portrait screen orientation in a different embodiment. FIG. 11B shows a virtual keypad in accordance with other example embodiment. The shown virtual keypad is a numeric keypad provided by a portrait screen orientation. In some embodiments, the virtual keyboard of FIG. 11A or virtual keypad of FIG. 11B is selected in accordance with a data type of the field which is selected when the keyboard or keypad is invoked. For example, the virtual keypad is invoked when the selected field is a numeric field and the virtual keyboard is invoked when the selected field is a alphabetic or alphanumeric field. The virtual keyboard or keypad may allow custom entry of values in the widget while taking advantage of its scrolling (or spinning) functionality which seeks to provide an more efficient and easy-to-use interface and potentially reducing the number of erroneous inputs.

FIG. 12A to 12C are screen captures of a widget for the user interface screen of FIG. 11A or 11B. The virtual keyboard or keypad may be used to input values in a text entry field for use in the selected field in the widget. The input in the text entry field does not need to match the sequential list of values associated with that field. In at least some embodiments, the input in the text entry field does need to match the data type and possibly data format for the field or it may be rejected. For example, an alphabetic character cannot be entered into a numeric field. As shown in FIGS. 12A to 12C, entry in the text entry field is automatically populated into the selected field.

In some embodiments, the values of the sequential list are dynamically changed in accordance with the current value of the selected field. Accordingly, the values before and after the current value shown in the widget of FIGS. 12A to 12C are dynamically determined based on the current value of the selected field. As more characters are input in the widget, from “2” to “20” to “200” the values in the sequential list are dynamically changed and the displayed values before and after the selected field are changed accordingly from “1” and “3”, to “19 and “21”, to “199” and “201”.

In the shown example embodiment the values in the sequential list defined a numeric series which values differ only by one, this is a function of the particular type of field, i.e. date fields. In other embodiments, the difference between values in the sequential list could be different, for example, 5, 10 or 15, and be unequal between values in the sequential list. Moreover, although the shown example embodiment relates to numeric values, the teachings of the present disclosure could be applied to non-numeric values. In some embodiments, the sized of each field is fixed in width according to the maximum number of character or digits. The value of each field may be center-aligned within each field. The number of characters or digits is fixed according to the data type of the field. At least some fields, such as numeric fields, may have a maximum and minimum value.

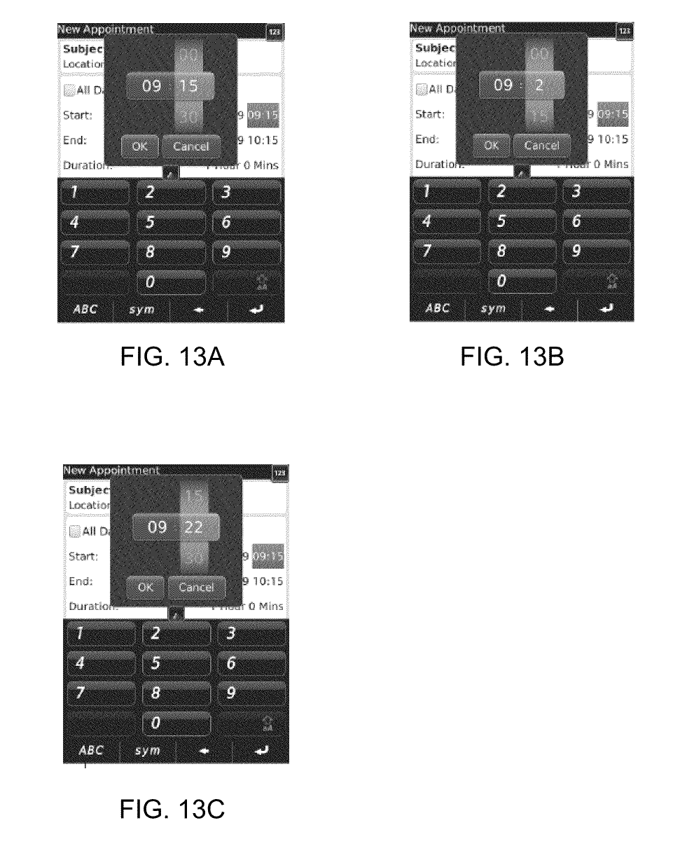

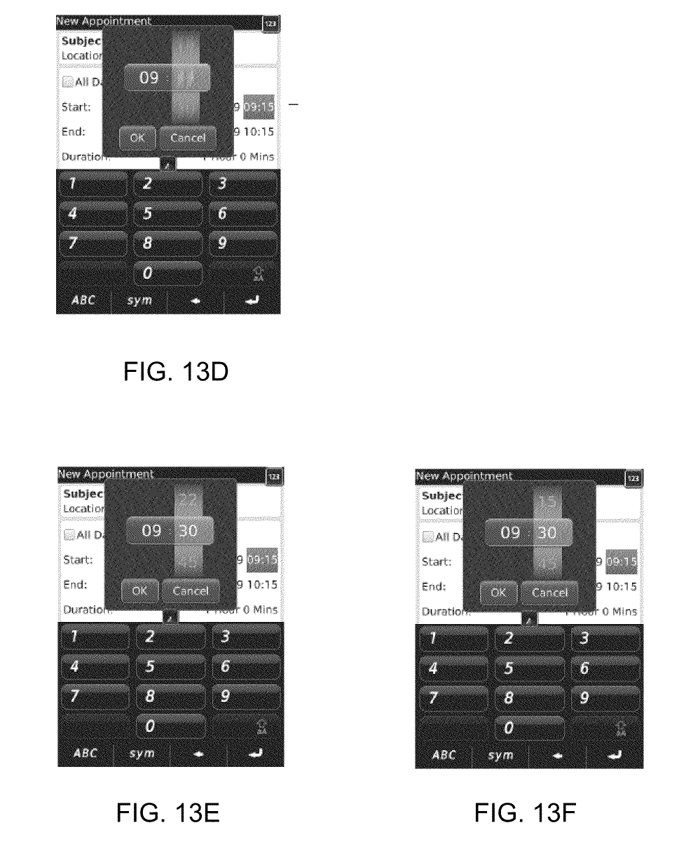

Referring now to FIG. 13A to 13C, modification of a minute field of a time widget in accordance with one example embodiment of the present disclosure will be described. Firstly, the minute field is selected and a virtual keypad is invoked as shown in FIG. 13A. Next, the user enters the value “2” in the entry field (FIG. 13C), followed by a second “2” to create the custom value of “22” (FIG. 13C). In the shown embodiment, the values before and after the custom value are the values in the sequential list between the custom value. Using the virtual keypad of the time widget, any number between the minimum and maximum value of the field could be input (e.g., any number between “0” and “59” for the minute field). Clicking on the minute field at this stage would result in accepting the input of “22” and the widget and virtual keypad would be removed. If the a corresponding time field or minute field in the application 148 which the widget was originally invoked is again selected or “clicked”, the widget will reappear with the custom value of “22” in the minute field.

If a predetermined touch gesture to change the value of the selected field is performed rather than clicking, the change of the selected field is changed in acceptance with the predetermine touch gesture (e.g. in occurrence with a direction of the touch event) as described above rather than accepting the value “22” and the customized value is discarded. If no input is detected within a predetermined duration of inputting the custom value, the widget times out and the customized value is discarded.

It will be appreciated the teachings in regards to widgets provided by present disclosure may also be used in the context on non-touchscreen devices where the navigation function provided by the touch-sensitive display 118 is provided by an alternate navigational device such as a trackball or scroll wheel. In such cases, scrolling or “spinning” is provided by movement of the trackball or scroll wheel in a corresponding direction when a field in the widget is selected.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein and in the recited claims intends to cover and embrace all suitable changes in technology.

1. A method of controlling touch input on a touch-sensitive display of a portable electronic device, the method comprising:
displaying a widget having at least one field on a user interface screen displayed on the touch-sensitive display;
selecting a field in the widget in response to predetermined interaction with the touch-sensitive display;
changing the value of the selected field in accordance with a predetermined touch gesture at any location on the touch-sensitive display; and
re-displaying the widget on the user interface screen with the changed value of the selected field.

2. The method of claim 1, wherein the predetermined touch gesture is a touch event having an initial contact point at any location on the touch-sensitive display which moves in one or more predetermined directions, wherein movement in a first direction scrolls forward through a sequential list of values for the selected field to select a new value for the selected field, and movement in a second direction scrolls backward through the sequential list of values for the selected field to select a new value for the selected field.

3. The method of claim 2, wherein the sequential list of values for the selected field is scrolled by an amount proportional to a distance that a centroid of the touch event has moved relative to the initial contact point.

4. The method of claim 2, wherein the first direction is upwards relative to a screen orientation of a graphical user interface (GUI) and the second direction is downwards relative to the screen orientation.

5. The method of claim 1, wherein the predetermined touch gesture is a touch event comprising a swipe gesture, wherein an upward swipe gesture at any location on the touch-sensitive display scrolls forward through a sequential list of values for the field to select a new value for the field, and wherein a downward swipe gesture at any location on the touch-sensitive display scrolls backward through the sequential list of values for the field to select a new value for the field.

6. The method of claim 5, wherein the sequential list of values for the selected field is scrolled by an amount proportional to a distance of the swipe gesture.

7. The method of claim 5, wherein the values in the sequential list wrap around to a beginning of the sequential list when an end of the sequential list is reached in response to scrolling forward in the sequential list, and wherein the values in the sequential list wrap around to the end of the sequential list when the beginning of the sequential list is reached in response to scrolling backward in the sequential list.

8. The method of claim 1, wherein the widget comprises a number of fields, wherein a leftward swipe gesture at any location on the touch-sensitive display scrolls leftward through the fields in the widget to select a new field, and wherein a rightward swipe gesture at any location on the touch-sensitive display scrolls rightward through the fields in the widget to select a new field.

9. The method of claim 1, wherein an up-arrow is displayed above the selected field and a down-arrow is displayed below the selected field in response to its selection, wherein a touch event at the up-arrow which exceeds a predetermined duration scrolls forward through a sequential list of values for the field to select a new value for the field, wherein a touch event at the up-arrow which exceeds the predetermined duration scrolls backward through the sequential list of values for the field to select a new value for the field.

10. The method of claim 1, wherein an up-arrow is displayed above the selected field and a down-arrow is displayed below the selected field in response to its selection, wherein the depressing the touch-sensitive display at a location of the up-arrow scrolls forward through a sequential list of values for the field to select a new value for the field, wherein depressing the touch-sensitive display at a location of the down-arrow scrolls backward through the sequential list of values for the field to select a new value for the field.

11. The method of claim 1, wherein depressing the touch-sensitive display at the location of the up-arrow moves the value of the field forward through the sequential list by one value, and wherein depressing the touch-sensitive display at the location of the down-arrow moves the value of the field backward through the sequential list by one value.

12. The method of claim 1, wherein the field of the widget is a spin box.

13. The method of claim 1, wherein selecting the field comprises moving an onscreen position indicator to the selected field.

14. The method of claim 13, wherein moving the onscreen position indicator to the selected field changes the appearance of the selected field to provide a visual indication of the selected field.

15. The method of claim 14, wherein the background colour and text colour of the selected field is changed by moving the onscreen position indicator to the selected field.

16. The method of claim 1, further comprising storing the changed value of the selected field in a memory of the portable electronic device in response to respective input.

17. A portable electronic device, comprising:
a processor;
a touch-sensitive display having a touch-sensitive overlay connected to the processor;
wherein the processor is configured for: causing a widget having at least one field to be displayed on a user interface screen displayed on the touch-sensitive display; selecting a field in the widget in response to predetermined interaction with the touch-sensitive display; changing the value of the selected field in accordance with a predetermined touch gesture at any location on the touch-sensitive display; and causing the widget to be re-displayed on the user interface screen with the changed value of the selected field.

18. The device of claim 17, wherein the predetermined touch gesture is a touch event having an initial contact point at any location on the touch-sensitive display which moves in one or more predetermined directions, wherein the processor is configured for: causing scrolling forward through a sequential list of values for the selected field to select a new value for the field in response to movement in a first direction; and causing scrolling backward through the sequential list of values for the selected field to select a new value for the field in response to movement in a second direction.

19. The device of claim 18, wherein the processor is configured for:
scrolling through the sequential list of values for the selected field by an amount proportional to a distance that a centroid of the touch event has moved relative to the initial contact point.

20. The device of claim 17, wherein the predetermined touch gesture is a touch event comprising a swipe gesture, wherein the processor is configured for: causing scrolling forward through a sequential list of values for the field to select a new value for the field in response to an upward swipe gesture at any location on the touch-sensitive display; and causing scrolling backward through the sequential list of values for the field to select a new value for the field response to a downward swipe gesture at any location on the touch-sensitive display.

21. The device of claim 20, wherein the processor is configured for: scrolling through the sequential list of values for the selected field by an amount proportional to a distance of the swipe gesture.

22. The device of claim 20, wherein the values in the sequential list wrap around to a beginning of the sequential list when an end of the sequential list is reached in response to scrolling forward in the sequential list, and wherein the values in the sequential list wrap around to the end of the sequential list when the beginning of the sequential list is reached in response to scrolling backward in the sequential list.

23. The device of claim 17, the widget comprises a number of fields, wherein the processor is configured for: causing scrolling leftward through the fields in the widget to select a new field in response to a leftward swipe gesture at any location on the touch-sensitive display; and causing scrolling rightward through the fields in the widget to select a new field in response to a rightward swipe gesture at any location on the touch-sensitive display.

24. The device of claim 17, wherein the processor is configured for: causing an up-arrow to be displayed above the selected field and causing a down-arrow to be displayed below the selected field in response to its selection; causing scrolling forward through a sequential list of values for the field to select a new value for the field in response to a touch event at the up-arrow which exceeds a predetermined duration; and causing scrolling backward through the sequential list of values for the field to select a new value for the field in response to a touch event at the down-arrow which exceeds the predetermined duration.

25. The device of claim 17, further comprising an actuator located beneath a back side of the touch-sensitive display opposite to the touch-sensitive overlay of the touch-sensitive display;
wherein the processor is configured for: causing an up-arrow to be displayed above the selected field and causing a down-arrow to be displayed below the selected field in response to its selection; causing scrolling forward through a sequential list of values for the field to select a new value for the field in response to the touch-sensitive display being pressed at a location of the up-arrow so to actuate the actuator; and causing scrolling backward through the sequential list of values for the field to select a new value for the field in response to the touch-sensitive display being pressed at a location of the down-arrow so to actuate the actuator.

26. The method of claim 1, further comprising:
displaying a virtual keyboard or virtual keypad in the user interface screen displayed on the touch-sensitive display in response to predetermined interaction with the touch-sensitive display when the field is selected; and
changing the value of the selected field in accordance with input in the virtual keyboard or virtual keypad; and
re-displaying the widget on the user interface screen with the changed value of the selected field in accordance with the input in the virtual keyboard or virtual keypad.

27. The method of claim 26, wherein the virtual keypad is displayed when the selected field is a numeric field, wherein the virtual keyboard is displayed when the selected field is an alphabetic or alphanumeric field.

28. The method of claim 26, wherein the predetermined touch gesture is a touch event having an initial contact point at any location on the touch-sensitive display which moves in one or more predetermined directions, wherein movement in a first direction scrolls forward through a sequential list of values for the selected field to select a new value for the selected field, and movement in a second direction scrolls backward through the sequential list of values for the selected field to select a new value for the selected field;
wherein, when the input in the virtual keyboard or virtual keypad does not match a value in the sequential list of values, the sequential list of values is dynamically changed in accordance with the changed value of the selected field in accordance with the input in the virtual keyboard or virtual keypad.

29. The method of claim 26, wherein the user interface screen is re-displayed with the virtual keyboard or virtual keypad in response to activating an actuator located beneath a back side of the touch-sensitive display when the field is selected and the virtual keyboard or virtual keypad is not displayed.

30. The method of claim 26, wherein the user interface screen is re-displayed without the virtual keyboard or virtual keypad in response to activating an actuator located beneath a back side of the touch-sensitive display when the virtual keyboard or virtual keypad is displayed.

31. The device of claim 17, wherein the processor is configured for: displaying a virtual keyboard or virtual keypad in the user interface screen displayed on the touch-sensitive display in response to predetermined interaction with the touch-sensitive display when the field is selected; changing the value of the selected field in accordance with input in the virtual keyboard or virtual keypad; and re-displaying the widget on the user interface screen with the changed value of the selected field in accordance with the input in the virtual keyboard or virtual keypad.

32. The device of claim 31, wherein the virtual keypad is displayed when the selected field is a numeric field, wherein the virtual keyboard is displayed when the selected field is an alphabetic or alphanumeric field.

33. The device of claim 31, wherein the predetermined touch gesture is a touch event having an initial contact point at any location on the touch-sensitive display which moves in one or more predetermined directions, wherein movement in a first direction scrolls forward through a sequential list of values for the selected field to select a new value for the selected field, and movement in a second direction scrolls backward through the sequential list of values for the selected field to select a new value for the selected field;
wherein, when the input in the virtual keyboard or virtual keypad does not match a value in the sequential list of values, the sequential list of values is dynamically changed in accordance with the changed value of the selected field in accordance with the input in the virtual keyboard or virtual keypad.

34. The device of claim 31, further comprising an actuator located beneath a back side of the touch-sensitive display opposite to the touch-sensitive overlay of the touch-sensitive display, wherein activating the actuator when the field is selected and the virtual keyboard or virtual keypad is not displayed causes the user interface screen to be re-displayed with the virtual keyboard or virtual keypad.

35. The device of claim 31, further comprising an actuator located beneath a back side of the touch-sensitive display opposite to the touch-sensitive overlay of the touch-sensitive display, wherein activating the actuator when the virtual keyboard or virtual keypad is displayed causes the user interface screen to be re-displayed without the virtual keyboard or virtual keypad.
